(19) United States
(12) Patent Application Publication
(10) Pub. No.: US 2007/0263561 A1
(43) Pub. Date: Nov. 15, 2007

(54) Techniques to control access point transmissions in wireless networks

(76) Inventor: Zohar Tsaba, (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/432,752

(22) Filed: May 10, 2006

(51) Int. Cl. H04Q 7/00

(52) U.S. Cl. 370/328

(57) ABSTRACT

An embodiment of the present invention provides an apparatus, comprising an access point (AP) operable in a wireless local area network, wherein transmissions by the AP are capable of being controlled by a wireless station (STA) in communication with the AP.

### BACKGROUND

Wireless networks have grown increasingly in importance and have varying uses. In a wireless local area network (it is understood that the present invention is not limited to wireless local area networks and may be used in any wireless network), it may be desirable to control the transmissions of an access point associated with the wireless local area network (WLAN). This may be desirable in order to reduce or avoid extra radio emissions (in a timeframe when no one is using it) such as, but not limited to a WLAN environment at home. Also, for security reasons limiting AP transmissions may be beneficial.

Thus, a strong need exists for techniques to control access point transmissions in wireless networks.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an apparatus, system and method of one embodiment of the present invention; and

FIG. 2 illustrates a flowchart of the method according to one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm, technique or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

as in a cause and effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like), wireless wide are networks (WWAN), wireless metropolitan area networks (WMAN) and Mesh networks.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

In a wireless network, such as, but not limited to, a wireless local area network (WLAN) an end user using a wireless station (STA) may want to control the access point (AP) transmit status. For example, once the user completed any transmit/receive packets with the AP, the user may want to shutdown the AP or change the AP transmit status to a “non-transmitting” mode (“receive only” mode). One reason the user may want to do this is to avoid extra radio emission during a timeframe when no one is using it. An embodiment of the present invention may be especially useful in a WLAN environment at home/SOHO (Small Office/Home Office) environment, when there are 1-2 users, and the users may want to avoid extra emissions at home both from data security reasons and from health/radiation reasons. Although it is understood that the present invention is not limited to these reasons for use and these usage scenarios.

In an embodiment of the present invention, another usage model may be when the AP is in “receive mode” (no transmit) at home. A user may turn on a STA (such as a laptop computer), and want to connect. Once your laptop is turned on, it may send a signal to the AP to change its state to transmit and receive. This usage model decreases the emission at home, saves power, increases security robustness (can't sniff to AP transmitted data most of the time), and avoids transmitting data while no need.

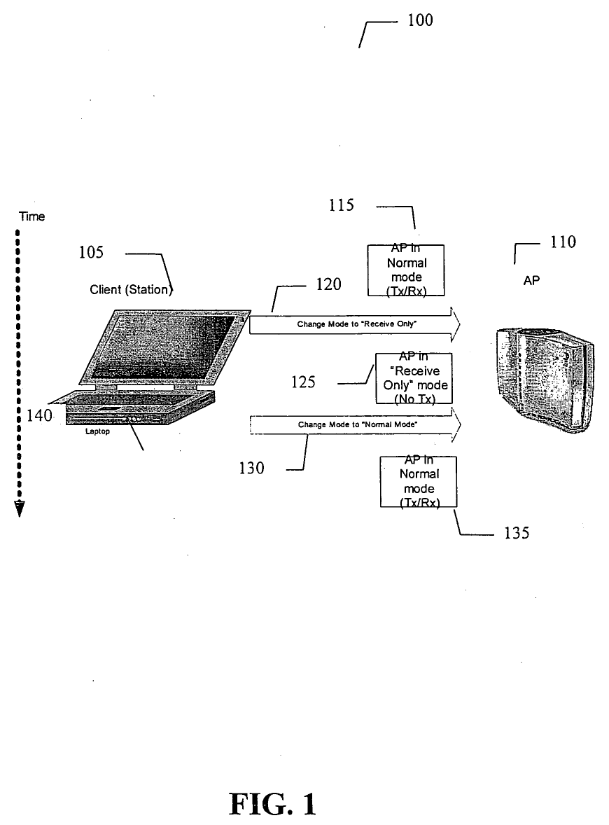

Turning now to the figures, FIG. 1 illustrates the system 100, which may include an apparatus and method according to one embodiment of the present invention. The station 105 should send a message 120 to the AP 110, currently in normal/transmit mode 115, asking to change the AP 110 mode to “receive only” mode 125. Once the AP 110 gets this message, the AP 110 will stop transmitting any further packets, and will stay in “receive only” mode 125. The AP 110 will stay in this mode until it gets another message 130 from the wireless station 105, asking to change the AP 110 mode back to normal 135. Another message may be used to shut down the AP 110 by the client completely (in this case, there is no way to get back to normal mode, since the AP is not “listening”).

In an embodiment of the present invention, there are a number of ways to implement the present invention, including, but not limited to:

1. Adding an extension to institute for electrical and electronic engineers (IEEE) 802.11 standard protocol. For example, but not limited to, adding a special frame type—“a message” frame. Once the AP gets such a frame, it reads it and acts according to the message content.

2. Using a specific “information elements”, as supported by the IEEE 802.11 standard.

3. The message may be embedded in the payload, and there may be a bit in the frame header that specifies it is a message, and not a normal data packet.

In an embodiment of the present invention, a security mechanism may also be added to avoid control of the AP by un-authorized users. The “Control Access Point Transmit status by a client station” mechanism should enable users to control any AP which the users has information about and has the right security rights to. Further, in an embodiment of the present invention, a dipole antenna may be used by the AP to facilitate transmission within the WLAN.

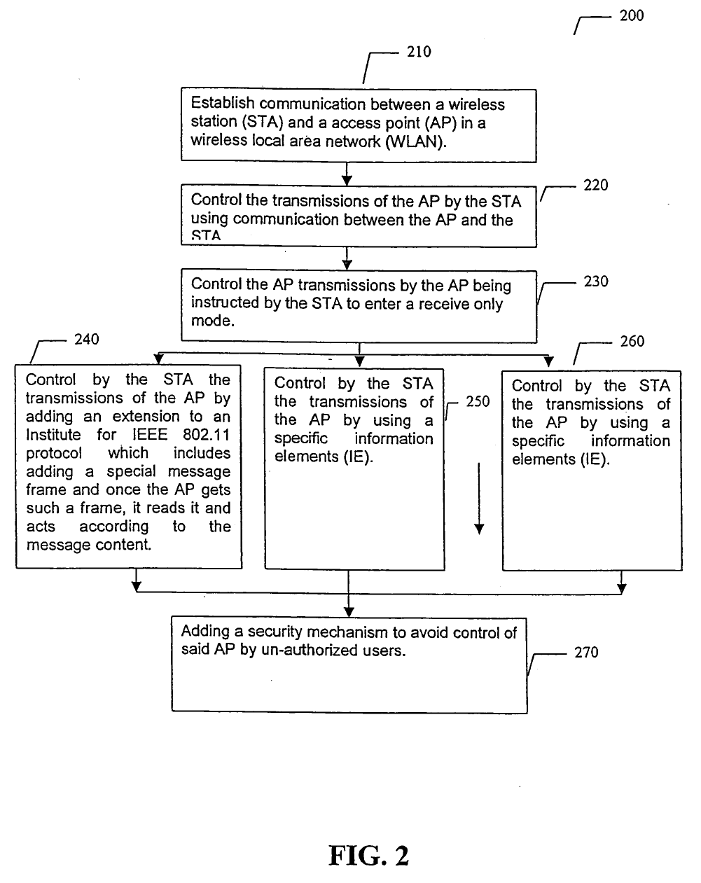

FIG. 2, generally at 200, provides a flowchart depicting the method of operation of one embodiment of the present invention. At 210 communications may be established between a wireless station (STA) and an access point (AP) in a wireless local area network (WLAN) and at 220 the transmissions by the AP may be controlled by the STA using communication between the AP and the STA. In these communications, at 230 the AP transmissions may be controlled by the AP being instructed by the STA to enter a receive only mode. This may be accomplished by:

240—Control by the STA the transmissions of the AP by adding an extension to an IEEE 802.11 protocol which includes adding a special message frame, and once the AP gets such a frame, it reads it and acts according to the message content; or

250—Control by the STA the transmissions of the AP by using a specific information elements (IE); or

260—Control by the STA the transmissions of the AP by using a specific information elements (IE).

At 270 a security mechanism may be included to avoid control of the AP by un-authorized users.

In yet another embodiment of the present invention is provided a machine-accessible medium that provides instructions, which when accessed, cause a machine to perform operations comprising controlling the transmissions of an access point (AP) operable in a wireless local area network by a wireless station (STA) in communication with the AP.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

I claim:

1. An apparatus, comprising:
an access point (AP) operable in a wireless local area network, wherein transmissions by said AP are capable of being controlled by a wireless station (STA) in communication with said AP.

2. The apparatus of claim 1, wherein said AP transmissions are controlled by said AP being instructed by said STA to enter a receive only mode.

3. The apparatus of claim 1, wherein said AP transmissions are controlled by said AP being instructed by said STA to shut down.

4. The apparatus of claim 2, wherein said AP is further capable of returning to a transmit and receive mode by being instructed to by said STA.

5. The apparatus of claim 1, wherein said STA controls said transmissions of said AP by adding an extension to an Institute for Electrical an Electronic Engineering (IEEE) 802.11 protocol which includes adding a special message frame and once the AP gets such a frame, it reads it and acts according to the message content.

6. The apparatus of claim 1, wherein said STA controls said transmissions of said AP by using a specific information elements (IE).

7. The apparatus of claim 1, wherein said STA controls said transmissions of said AP by a message embedded in a payload with a bit in a frame header that specifies it is a message, and not a normal data packet.

8. The apparatus of claim 1, further comprising a security mechanism to avoid control of said AP by un-authorized users.

9. A method, comprising:
controlling the transmissions of an access point (AP) by a wireless station (STA) in communication with said AP.

10. The method of claim 9, further comprising controlling said AP transmissions by said AP being instructed by said STA to enter a receive only mode.

11. The method of claim 9, further comprising controlling said AP transmissions by said AP being instructed by said STA to shut down.

12. The method of claim 10, further comprising returning to a transmit and receive mode by said AP by being instructed to by said STA.

13. The method of claim 9, further comprising controlling by said STA said transmissions of said AP by adding an extension to an Institute for Electrical an Electronic Engineering (IEEE) 802.11 protocol which includes adding a special message frame and once the AP gets such a frame, it reads it and acts according to the message content.

14. The method of claim 9, further comprising controlling by said STA said transmissions of said AP by using a specific information elements (IE).

15. The method of claim 9, further comprising controlling by said STA said transmissions of said AP by a message embedded in a payload with a bit in a frame header that specifies it is a message, and not a normal data packet.

16. The method of claim 9, further comprising adding a security mechanism to avoid control of said AP by un-authorized users.

17. A machine-accessible medium that provides instructions, which when accessed, cause a machine to perform operations comprising:
controlling the transmissions of an access point (AP) operable in a wireless local area network by a wireless station (STA) in communication with said AP.

18. The machine-accessible medium of claim 17, further comprising said instructions causing said machine to perform operations further comprising controlling said AP transmissions by said AP being instructed by said STA to enter a receive only mode.

19. The machine-accessible medium of claim 17, further comprising said instructions causing said machine to perform operations further comprising controlling said AP transmissions by said AP being instructed by said STA to shut down.

20. The machine-accessible medium of claim 18, further comprising said instructions causing said machine to perform operations further comprising returning to a transmit and receive mode by said AP by being instructed to by said STA.

21. The machine-accessible medium of claim 17, further comprising said instructions causing said machine to perform operations further comprising controlling by said STA said transmissions of said AP by adding an extension to an Institute for Electrical an Electronic Engineering (IEEE) 802.11 protocol which includes adding a special message frame and once the AP gets such a frame, it reads it and acts according to the message content.

22. The machine-accessible medium of claim 17, further comprising said instructions causing said machine to perform operations further comprising controlling by said STA said transmissions of said AP by using a specific information elements (IE).

23. The machine-accessible medium of claim 17, further comprising said instructions causing said machine to perform operations further comprising controlling by said STA said transmissions of said AP by a message embedded in a payload with a bit in a frame header that specifies it is a message, and not a normal data packet.

24. The machine-accessible medium of claim 17, further comprising said instructions causing said machine to perform operations further comprising adding a security mechanism to avoid control of said AP by un-authorized users.

25. A system, comprising:
an access point (AP) operable in a wireless local area network; and
a wireless station in communication with said AP and capable of controlling the transmissions of said AP into said wireless local area network.

26. The system of claim 25, wherein said AP transmissions are controlled by said AP being instructed by said STA to enter a receive only mode.

27. The system of claim 25, wherein said AP transmissions are controlled by said AP being instructed by said STA to shut down.

28. The system of claim 26, wherein said AP is further capable of returning to a transmit and receive mode by being instructed to by said STA.

29. The system of claim 25, wherein said STA controls said transmissions of said AP by adding an extension to an Institute for Electrical an Electronic Engineering (IEEE) 802.11 protocol which includes adding a special message frame and once the AP gets such a frame, it reads it and acts according to the message content.

30. The system of claim 25, wherein said STA controls said transmissions of said AP by using a specific information elements (IE).

31. The system of claim 25, wherein said STA controls said transmissions of said AP by a message embedded in a payload with a bit in a frame header that specifies it is a message, and not a normal data packet.

32. The system of claim 25, further comprising a security mechanism to avoid control of said AP by un-authorized users.

33. A system, comprising:
an access point (AP) operable in a wireless local area network;
a dipole antenna connected to said AP; and
a wireless station in communication with said AP via said dipole antenna and capable of controlling the transmissions of said AP into said wireless local area network.
